(19) United States
(12) Patent Application Publication
(10) Pub. No.: US 2007/0136562 A1
(43) Pub. Date: Jun. 14, 2007

(54) Decoupling register bypassing from pipeline depth

(76) Inventors: Paul Caprioli, Mountain View, CA (US); Shailender Chaudhry, San Francisco, CA (US); Marc Tremblay, Menlo Park, CA (US)

Correspondence Address: SUN MICROSYSTEMS INC.;C/O PARK, VAUGHAN & FLEMING LLP, 2820 FIFTH STREET, DAVIS, CA, 95618-7759, US

(21) Appl. No.: 11/364,479

(22) Filed: Feb. 27, 2006

Related U.S. Application Data
(60) Provisional application No. 60/749,143, filed on Dec. 9, 2005.

(51) Int. Cl. G06F 9/30

(52) U.S. Cl. 712/217; 712/218

(57) ABSTRACT

One embodiment of the present invention provides a system which decouples register bypassing from pipeline depth. The system starts by storing an intermediate result generated by an originating instruction to an allocated location in an architectural-commit first-in-first-out (ACFIFO) structure and to an allocated location in a working register file (WRF). The system then bypasses the intermediate result from the WRF to subsequent dependent instructions until the originating instruction retires from the instruction execution pipeline. Next, the system stores the intermediate result from the ACFIFO structure to a location in an ARF when the originating instruction retires from the instruction execution pipeline. The system then removes the intermediate result from the WRF and the ACFIFO structure when the intermediate result has been stored in the ARF.

### RELATED APPLICATION

This application hereby claims priority under 35 U.S.C. section 119 to U.S. Provisional Patent Application No. 60/749,143 filed 09 Dec. 2005, entitled “Decoupling Register Bypassing from Pipeline Depth,” by inventors Paul Caprioli, Shailender Chaudhry, and Marc Tremblay (Attorney Docket No. SUN05-0267PSP).

### BACKGROUND

1. Field of the Invention

The present invention relates to techniques for improving the performance of computer systems. More specifically, the present invention relates to a method and an apparatus for improving computer system performance by decoupling register bypassing from pipeline depth.

2. Related Art

The dramatic increases in processor clock speeds in recent years have required processor designers to develop sophisticated mechanisms to support pipelined execution. For example, FIG. 1 illustrates a pair of register files used by a typical in-order processor 104 to store results generated during pipelined instruction execution. More specifically, FIG. 1 includes architectural register file (ARF) 102 and working register file (WRF) 103 along with Arithmetic Logic Unit (ALU) 100 and ALU 101.

Each of these ALUs includes pipelined logic circuits which perform operations to execute instructions. Note that ALU 100 is a one-cycle ALU and therefore only supports one-cycle instructions. ALU 101, on the other hand, is a multi-cycle ALU which supports both one-cycle instructions and longer-latency three-cycle instructions.

ARF 102 is a register file which holds the architecturally committed results generated by instructions which have retired from the execution pipelines in processor 104. ARF 102 therefore holds values which are safe for unconditional use as inputs for subsequent dependent instructions.

WRF 103 contains the intermediate results of “originating instructions,” which are instructions that have completed executing, but have not yet retired from the pipeline. Processor 104 executes these originating instructions within ALUs 100 and 101 and writes the intermediate results to WRF 103. As seen in FIG. 1, the one-cycle ALU 100 writes intermediate results to WRF 103 from register file (RF) write stage 106. Alternatively, multi-cycle ALU 101 writes WRF 103 from both RF write stage 106 and RF write stage 107. Processor 104 bypasses the intermediate results from WRF 103 to subsequent dependent instructions until the originating instruction retires from the pipeline and the intermediate results are architecturally committed to ARF 102.

Bypassing significantly improves the performance of processor 104, because without bypassing processor 104 is forced to stall the execution of each dependent instruction until the originating instruction retires from the pipeline.

Although ARF 102 and WRF 103 facilitate bypassing, the combination of ARF 102 and WRF 103 gives rise to several problematic technical issues. For example, WRF 103 is typically designed as a content addressable memory (CAM) structure, containing a memory element for each pipeline stage and more than a dozen read and write ports. As with any large CAM structure, area and power dissipation can create problems. In addition, because WRF 103 includes a memory location for each stage of each pipeline, every adjustment in the number of pipeline stages requires the re-floor-planning of both WRF 103 and the area around WRF 103. This is a particular concern when pipeline stage adjustments are made late in the design cycle.

Another issue is the handling of traps (or interrupts). Some of the intermediate results stored in WRF 103 are only used by a few subsequent instructions before being overwritten. If a trap occurs after these intermediate results have been overwritten, the intermediate results could be lost. In order to prevent such data corruption, additional control circuitry must be included in WRF 103. Note that this type of data corruption can be a significant problem in processors which support the swapping of register windows. Because processor 104 continuously swaps register windows, the occurrence of a trap can easily catch processor 104 with invalid values in the active register window.

A further issue has to do with writing restrictions for ARF 102. A typical ARF, such as ARF 102, has a logical register for each available register in each pipeline, but only one write port into each of the associated sets of physical registers. Consequently, ARF 102 prevents simultaneous writes to a logical register. This restriction can hamper the timely in-order execution of instructions in the affected pipelines.

Hence, what is needed is a processor which supports register bypassing without the above-listed problems.

### SUMMARY

One embodiment of the present invention provides a system which decouples register bypassing from pipeline depth. The system starts by storing an intermediate result generated by an originating instruction to an allocated location in an architectural-commit first-in-first-out (ACFIFO) structure and to an allocated location in a working register file (WRF). The system then bypasses the intermediate result from the WRF to subsequent dependent instructions until the originating instruction retires from the instruction execution pipeline. Next, the system stores the intermediate result from the ACFIFO structure to a location in an ARF when the originating instruction retires from the instruction execution pipeline. The system then removes the intermediate result from the WRF and the ACFIFO structure when the intermediate result has been stored in the ARF.

In a variation of this embodiment, the system maintains an enqueue pointer which indicates a location within the ACFIFO structure for storing an intermediate result generated by the execution of a next originating instruction; a commit pointer which indicates a location within the ACFIFO structure where an intermediate result was stored by an originating instruction that has passed a trap stage of the instruction execution pipeline; and a dequeue pointer which indicates a location within the ACFIFO structure where an intermediate result, which is ready to be written to the ARF, is stored.

In a further variation, the system shifts the enqueue pointer to indicate the next location in the ACFIFO structure as each instruction is issued. The system also shifts a commit pointer to indicate the next location in the ACFIFO structure as each originating instruction passes a trap stage of the instruction execution pipeline. In addition, the system shifts the dequeue pointer to indicate the next location in the ACFIFO structure after the stored intermediate result indicated by the dequeue pointer has been successfully written to the ARF.

In a variation of this embodiment, the system disables ARF writes from the ACFIFO structure when: (1) the dequeue pointer indicates the same location as the commit pointer; (2) the system is clearing the pre-trap-stage intermediate results from the ACFIFO structure during the handling of a trap; (3) an ARF control circuit disables writes to the ARF; or (4) an entry in a location of the ACFIFO structure indicated by the dequeue pointer is not valid.

In a variation of this embodiment, the system stores an index for the location in the ACFIFO indicated by the enqueue pointer as each instruction is issued. The system then uses this index to store the intermediate results to the ACFIFO after the instruction is executed.

In a variation of this embodiment, the system decrements the value of an ACFIFO-credit variable as locations in the ACFIFO structure are allocated and increments the value of the ACFIFO-credit variable as locations within the ACFIFO structure are released.

In a further variation, the system halts issuing instructions while the value of the ACFIFO-credit variable equals zero.

In a variation of this embodiment, the system decrements the value of a WRF-credit variable as locations in the WRF are allocated and increments the value of the WRF-credit variable as locations in the WRF are released.

In a further variation, the system halts issuing instructions if the value of the WRF-credit variable equals zero.

In a variation of this embodiment, the system stores an intermediate result generated by a second originating instruction in a second instruction execution pipeline to an allocated location in a second ACFIFO structure and to an allocated location in the WRF. The system then bypasses the intermediate result from the WRF to subsequent dependent instructions in the second instruction execution pipeline until the second originating instruction retires from the second instruction execution pipeline. The system next stores the intermediate result from the second ACFIFO structure to a location in the ARF when the second originating instruction retires from the additional instruction execution pipeline. The system then removes the intermediate result from the WRF and the second ACFIFO structure when the intermediate result has been stored in the ARF.

In a variation of this embodiment, the system maintains an age pointer which indicates the pipeline position of a second originating instruction issued at the same time as the originating instruction.

### BRIEF DESCRIPTION OF THE FIGURES

FIG. 1 illustrates a pair of register files in an in-order processor.

FIG. 2 illustrates the design of a processor in accordance with an embodiment of the present invention.

FIG. 3 illustrates an ACFIFO structure in accordance with an embodiment of the present invention.

FIG. 4 illustrates age pointers in accordance with an embodiment of the present invention.

FIG. 5 presents a flow chart illustrating instruction issuance in a processor that includes an ACFIFO in accordance with an embodiment of the present invention.

FIG. 6 presents a flow chart illustrating a write from an ACFIFO to an ARF in accordance with an embodiment of the present invention.

FIG. 7 presents a flow chart illustrating trap handling on a processor that includes an ACFIFO in accordance with an embodiment of the present invention.

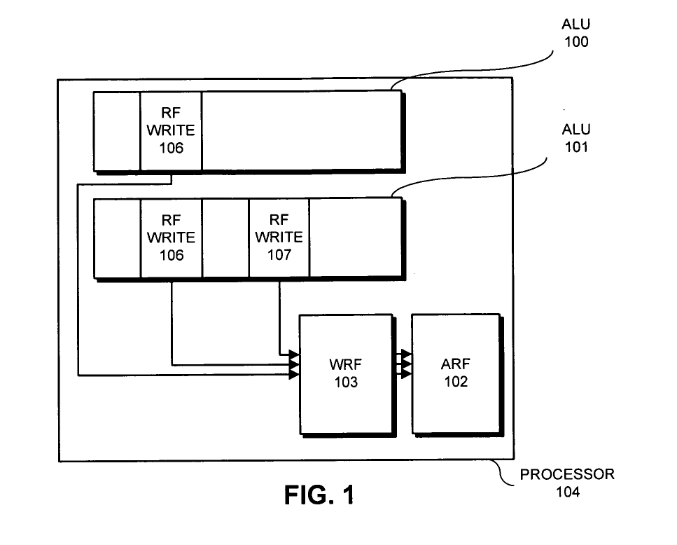

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The term “originating instruction” is hereby defined as an instruction which has completed executing, but has not yet retired from the pipeline. Furthermore, the term “intermediate result” is defined as the result generated during the execution of an originating instruction, before that originating instruction has retired from the pipeline and the intermediate result has been architecturally committed to the ARF. Note that intermediate results may need to be discarded if operating conditions prevent the originating instruction from properly completing retirement (such as a trap condition causing a flush of the pipeline).

Processor with Architectural-Commit First-In-First-Out Structures

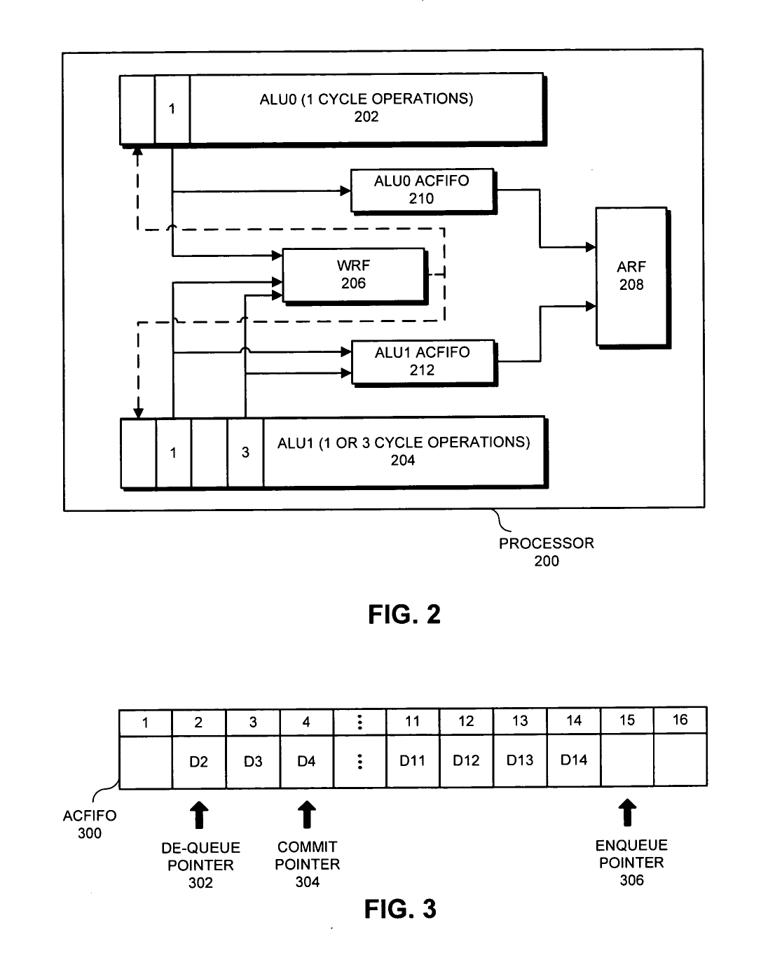

FIG. 2 illustrates the design of a processor 200 in accordance with an embodiment of the present invention. Processor 200 can generally include any type of processor, including, but not limited to, a microprocessor, a mainframe computer, a digital signal processor, a personal organizer, a device controller, and a computational engine within an appliance.

Processor 200 includes: arithmetic logic unit 0 (ALU®) 202, arithmetic logic unit 1 (ALU1) 204, working register file (WRF) 206, architectural register file (ARF) 208, A0 architectural-commit-FIFO (A0 ACFIFO) 210, and A1 architectural-commit-FIFO (A1 ACFIFO) 212.

ALU0 202 and ALU1 204 are circuit structures that perform computations for processor 200. ALU0 202 is a one-cycle operation ALU, and hence only handles computations which complete in one cycle, such as SUB and INCR. On the other hand, ALU1 204 is a multi-cycle ALU. Therefore, ALU1 204 can handle more complex multi-cycle operations, such as DIV, in addition to the simpler one-cycle operations.

ARF 208 is a register file which contains results of instructions which have been committed to the architectural state of the processor. In other words, the instructions which generated the results that are stored in ARF 208 have retired from the pipeline and these results are safe for unconditional use by subsequent dependent instructions.

WRF 206 is a register file used for storing intermediate results from originating instructions. When an originating instruction produces an intermediate result, processor 200 writes a copy of the intermediate result into WRF 206. Processor 200 can then bypass this intermediate result from WRF 206 to subsequent dependent instructions (as indicated by the dashed line in FIG. 2). When the originating instruction eventually retires from the pipeline, processor 200 clears the intermediate result from WRF 206 and releases the location in WRF 206 for use by a subsequent instruction.

ACFIFO 210 and ACFIFO 212 are first-in-first-out (FIFO) memory structures which include a number of locations for storing intermediate results. Note that each set of pipeline execution stages on processor 200 has a corresponding ACFIFO. For example, in FIG. 2, ACFIFO 210 corresponds to execution stages in ALU® 202, while ACFIFO 212 corresponds to execution stages in ALU1 204. When an originating instruction completes execution in either ALU0 or ALU1, processor 200 writes a copy of the intermediate results into the corresponding ACFIFO. As the originating instruction retires, the intermediate results are committed to ARF 208 from the ACFIFO.

In one embodiment, WRF 206 has fewer storage locations than the total number of intermediate results that processor 200 may need to maintain simultaneously. Consequently, WRF overflow becomes a potential problem. To prevent WRF overflow, processor 200 maintains a “WRF-credit variable.” The WRF-credit variable is initialized to a value corresponding to the number of available locations in WRF 206. As the locations in WRF 206 are allocated to instructions, processor 200 decrements the WRF-credit variable. As these instructions retire and the locations in WRF 206 are released, processor 200 increments the WRF-credit variable. If the value of the WRF-credit variable reaches zero, processor 200 halts issuing further instructions, but permits the pipeline to keep retiring originating instructions. As originating instructions retire, locations in WRF 206 are released and the WRF-credit variable is incremented to a value greater than zero. Processor 200 then releases the halt condition and resumes issuing instructions. In an alternative embodiment, the WRF 206 has a number of storage locations that is equal to the number of intermediate results which can exist simultaneously on processor 200. In this case, the WRF-credit variable is unnecessary.

In one embodiment, the ACFIFOs include fewer storage locations than the total number of intermediate results which can exist simultaneously on processor 200. Consequently, ACFIFO overflow becomes a potential problem. To prevent ACFIFO overflow, processor 200 maintains an “ACFIFO-credit variable” for each ACFIFO. Each ACFIFO-credit variable is initialized to a value corresponding to the number of available locations in the associated ACFIFO. As the locations in each ACFIFO are allocated to originating instructions, processor 200 decrements the associated ACFIFO-credit variable. As the originating instructions retire and the locations in each ACFIFO are released, processor 200 increments the associated ACFIFO-credit variable. If the value of the ACFIFO-credit variable reaches zero, processor 200 halts the issuing of further instructions for the pipeline associated with the ACFIFO, but permits the pipeline to continue retiring originating instructions. As these originating instructions retire from the pipeline, locations in the associated ACFIFO are released and the associated ACFIFO-credit variable is incremented to a value greater than zero. Processor 200 then releases the halt condition and resumes issuing instructions. In an alternative embodiment, each ACFIFO has a number of storage locations equal to the number of intermediate results which can exist simultaneously on processor 200. In this case, the ACFIFO-credit variable is unnecessary.

ACFIFO Structure

FIG. 3 illustrates one embodiment of an ACFIFO structure. In particular, FIG. 3 illustrates ACFIFO 300, dequeue pointer 302, commit pointer 304, and enqueue pointer 306. ACFIFO 300 is a FIFO register file which stores intermediate results generated during the execution of originating instructions on processor 200 (see FIG. 2). As each originating instruction retires, the intermediate result is committed to ARF 208 from ACFIFO 300.

Note that ACFIFO 300 replaces WRF 206 as the location for storing intermediate results prior to storing these intermediate results to ARF 208. Hence, WRF 206 is no longer required to include a storage location for each pipeline stage on the processor. Using ACFIFO 300 to perform this function of WRF 206 results in significant area and power consumption savings, both because WRF 206 can be smaller and because ACFIFO 300 is a much simpler circuit structure.

Enqueue pointer 306 indicates the location in ACFIFO 300 where processor 200 should store the next intermediate result. Processor 200 advances enqueue pointer 306 with each issued instruction. Even though enqueue pointer 306 is advanced with each issued instruction (thereby allocating a location within ACFIFO 300 for the intermediate result of that instruction) not every issued instruction produces valid output. Consequently, processor 200 monitors the write to ARF 208 as each instruction retires. If the instruction did not produce valid output, processor 200 skips the ARF write from that location in ACFIFO 300.

Intermediate results are not always generated in the same pipeline execution stage. For example some execution stages write their intermediate results in the first stage of execution (see ALU0 or ALU1 in FIG. 2), while other execution stages write their intermediate results in the third stage of execution (see ALU1). Consequently, processor 200 stores an index for the location in ACFIFO 300 specified by enqueue pointer 306 as each instruction is issued. This index is then used to write the intermediate result to ACFIFO 300 when the intermediate result is generated.

Commit pointer 304 indicates the location within ACFIFO 300 that contains the most-recent intermediate result whose originating instruction has passed the trap stage of the pipeline. Since the originating instruction which generated this intermediate result has passed the trap stage, the result is safe to write into ARF 208. Processor 200 advances commit pointer 304 for each such originating instruction that passes the trap stage.

ACFIFO 300 contains the intermediate results for each originating instruction in the pipeline. Processor 200 therefore contains an in-order list of the intermediate results of executed originating instructions. Consequently, because the commit pointer indicates the location within ACFIFO 300 where the last committable intermediate result is located, no additional controls are required for trap handling. When handling a trap condition, processor 200 simply commits the intermediate results following the commit pointer in ACFIFO 300 and then initiates the trap handling routine.

Dequeue pointer 302 indicates the location within ACFIFO 300 that contains an intermediate result which is ready to be written to ARF 208. Processor 200 advances dequeue pointer 302 as each intermediate result is successfully written to ARF 208.

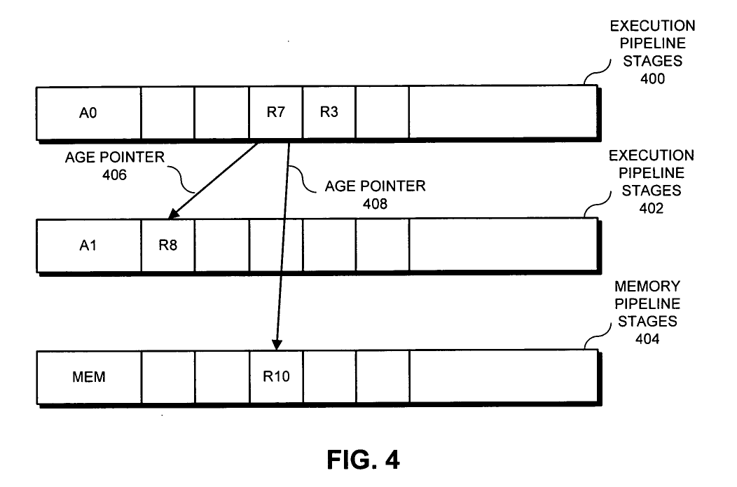

If a write to ARF 208 from a location indicated by dequeue pointer 302 is unsuccessful, processor 200 does not advance the dequeue pointer, but instead attempts the write again at a later time. Hence, dequeue pointer 302 facilitates out-of-order ARF writes for the intermediate results on separate pipelines. Despite allowing out-of-order writes between pipelines, processor 200 enforces ordering for intermediate results within a single pipeline. Note that dependencies between retiring instructions among separate pipelines are protected using age pointers (see FIG. 4).

During normal execution (or non-trap handling execution—see FIG. 7), processor 200 does not complete the ARF write if the location indicated by dequeue pointer 302 is the ahead of the location indicated by commit pointer 304. Preventing this type of write avoids committing an instruction which has not yet passed the trap stage of the pipeline to ARF 208.

If enqueue pointer 306 catches dequeue pointer 302, ACFIFO 300 is full. Processor 200 then halts issuing instructions for the associated pipeline until an originating instruction retires and releases a position in ACFIFO 300.

In one embodiment, ACFIFO 300 is structured as a ring buffer, wherein each pointer (including pointers 302, 304, and 306) wraps around from position 15 back to position 0 as the pointer advances.

Age Pointers

FIG. 4 illustrates one embodiment of age pointers. Because processor 200 (see FIG. 2) can use dequeue pointer 302 (see FIG. 3) to complete ARF 208 writes out-of-order from an ACFIFO, processor 200 must maintain age pointers 406 to enforce instruction retirement order between different pipelines. FIG. 4 illustrates execution pipeline stages 400, execution pipeline stages 402, memory pipeline stages 404, age pointer 406, and age pointer 408.

Age pointers 406 and 408 are used as follows. Processor 200 initializes age pointers 406 and 408 when issuing each instruction to execution pipeline stages 400. When initializing the age pointers, processor 200 sets the age pointers to indicate the instructions in execution pipeline stages 402 and memory pipeline stages 404 which are being issued at the same time as the instruction in execution pipeline stages 400. Processor 200 then uses age pointer 406 and age pointer 408 to track the progress of the instructions in execution pipeline stages 402 and memory pipeline stages 404 relative to execution pipeline stages 400. Processor 200 assures that the issued instruction does not retire before the retirement of any instruction which conflicts with the results of the issued instruction in one of the other pipelines.

Although the processor forces the instructions to retire “in order” with respect to write-after-write dependencies, the stages of the different pipelines on the processor are not in “lock-step” with one another. Processor 200 can halt or advance a pipeline relative to the other pipelines as long as dependencies are not threatened.

Issue Flowchart

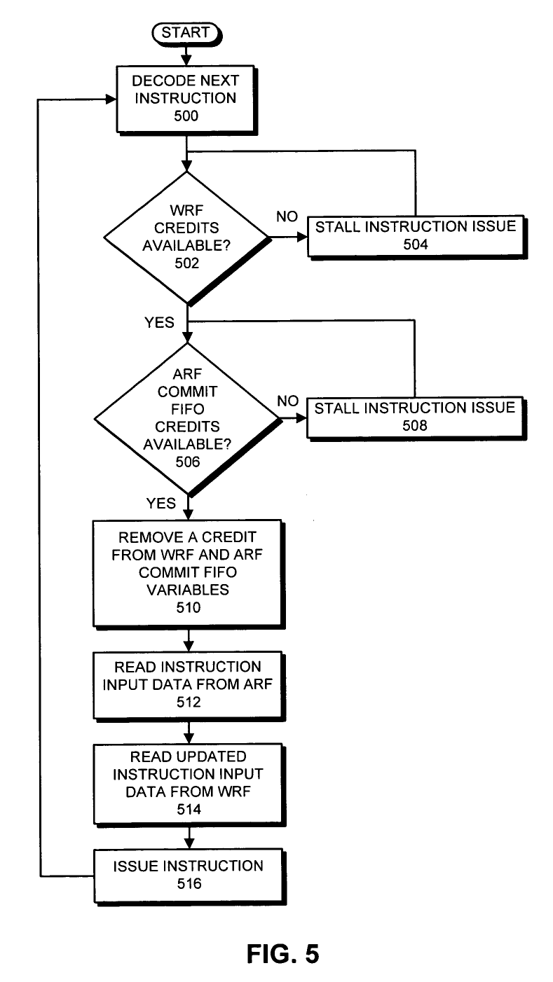

FIG. 5 presents a flow chart illustrating instruction issuance in one embodiment of a processor that includes an ACFIFO. The process starts when processor 200 (see FIG. 2) decodes the next instruction in program order (step 500).

Processor 200 then checks the value of a WRF-credit variable to determine if the value of the variable is non-zero (if WRF “credits” are available) (step 502). If the value of the WRF-credit variable is zero, there are no locations available within WRF 206 and processor 200 stalls the issuance of the decoded instruction (step 504). Processor 200 then returns to step 502 to re-check the value of the WRF-credit variable.

On the other hand, if the value of the WRF-credit variable is non-zero, processor 200 determines if the value of the ACFIFO-credit variable is non-zero (if ACFIFO “credits” are available) (step 506). If the value of the ACFIFO-credit variable is zero, there are no locations available within ACFIFO 210 and processor 200 stalls the issuance of the decoded instruction (step 508). Processor 200 then returns to step 506 to re-check the value of the ACFIFO-credit variable.

If the value of the ACFIFO-credit variable is non-zero, processor 200 allocates a space in both WRF 206 and ACFIFO 210 for the result of the instruction. Processor 200 allocates the space by: (1) storing the index of the location indicated by the enqueue pointer for future use when the intermediate result is subsequently written to ACFIFO 210; (2) decrementing the WRF-credit variable; and (3) decrementing the ACFIFO-credit variable (step 510).

Processor 200 then reads the architecturally committed input values for the instruction from ARF 208 (step 512). The architecturally committed values are the default inputs for the instruction. Next, processor 200 attempts to read intermediate results of a prior instruction from WRF 206 as inputs for the instruction (step 514). If these intermediate results are available, processor 200 uses them as inputs in place of the architecturally committed values read from ARF 208 in step 512. Processor 200 then issues the instruction (step 516) and returns to step 500 to issue the next instruction in program order.

Dequeue Flowchart

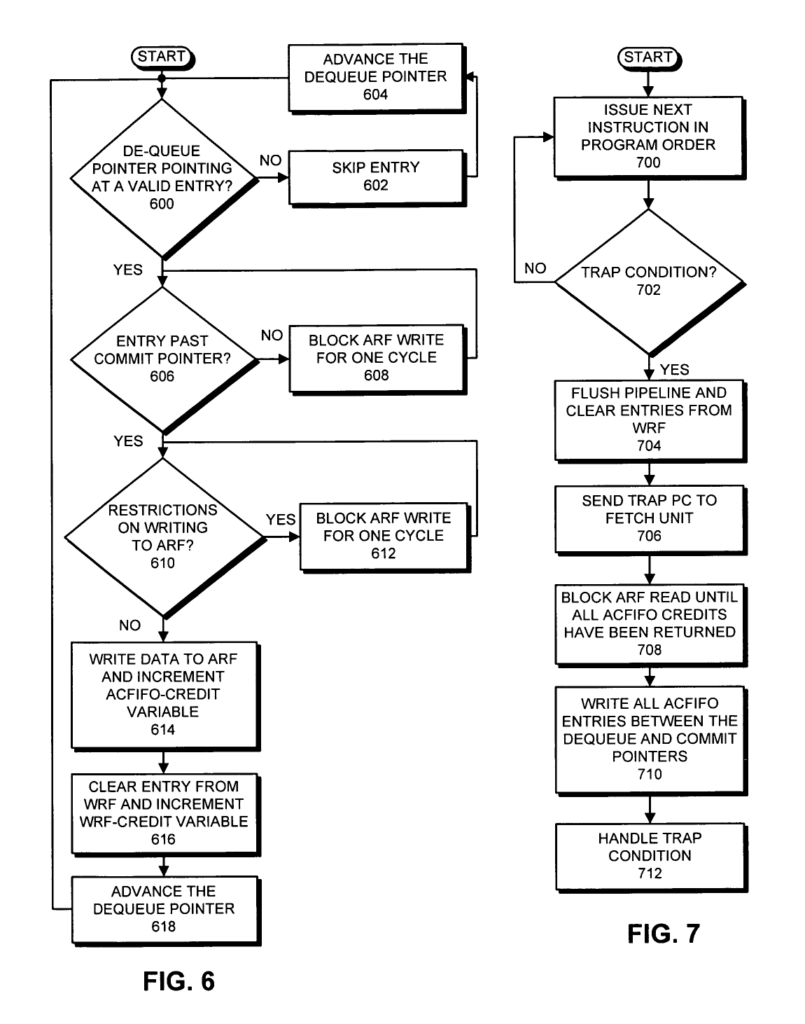

FIG. 6 presents a flow chart illustrating a write from an ACFIFO 210 to an ARF 208 in accordance with an embodiment of the present invention. The process starts as an instruction retires. At this point, processor 200 determines if dequeue pointer 302 (see FIG. 3) indicates a valid entry in ACFIFO 210 (step 600). If not, processor 200 skips the entry (step 602). Processor 200 then advances dequeue pointer 302 (step 604) and returns to step 600 to determine if dequeue pointer 302 is pointed at a valid entry as the next instruction retires.

If dequeue pointer 302 is pointed at a valid entry, processor 200 determines if dequeue pointer 302 is ahead of commit pointer 304 (step 606). If so, the instruction which created the entry in ACFIFO 210 is not past the trap stage of the pipeline and the entry cannot be written to ARF 208. If the entry was written to ARF 208, a subsequent trap condition could render the entry in ARF 208 invalid. Consequently, processor 200 prevents the ARF 208 write for one cycle (step 608). Processor 200 then returns to step 606 to determine if dequeue pointer 302 is ahead of commit pointer 304.

Processor 200 then determines if there are any restrictions on writing to ARF 208 (step 610). Such a restriction occurs when simultaneous writes to a logical register from two or more pipelines collide on a single write line to a physical register. If there is a restriction on writing to ARF 208, processor 200 prevents the ARF 208 write for one cycle (step 612).

If there is no restriction on writing to ARF 208, processor 200 writes the entry into the proper location in ARF 208, clears the intermediate result from the ACFIFO, and increments the ACFIFO-credit variable (step 614). Processor 200 also removes the intermediate result from WRF 206 and increments the WRF-credit variable (step 616). Processor 200 then advances dequeue pointer 302 (step 618) and returns to step 600 to determine if dequeue pointer 302 is pointed at a valid entry.

Trap Handling Flowchart

FIG. 7 presents a flow chart illustrating trap handling on a processor that includes an ACFIFO in accordance with one embodiment of the present invention. The process starts when processor 200 (see FIG. 2) issues an instruction in program order (step 700). Processor 200 then executes the instruction and determines if the instruction causes a trap condition (step 702). If not, processor 200 returns to step 700 and issues the next instruction in program order.

Otherwise, if the instruction does cause a trap condition, processor 200 starts the trap handling routine by flushing the pipeline and clearing the WRF 206 (step 704). Processor 200 then sends the trap program counter (PC) to the fetch unit, permitting the fetch unit to commence fetching trap handling instructions (step 706). However, processor 200 prevents subsequent ARF 208 reads until the handling of the trap condition is complete (step 708). Preventing the reads from ARF 208 prevents processor 200 from executing instructions until the entries in the ACFIFO 210 and ACFIFO 212 have cleared and the processor is in the correct architectural state to properly handle the trap condition.

Processor 200 then clears the intermediate results from ACFIFO 210 and ACFIFO 212 (step 710). In doing so, processor 200 writes all ACFIFO entries after commit pointer 304 (see FIG. 3) to the ARF 208 (completing the normal retirement procedure for these results). Processor 200 also clears the entries before commit pointer 304, but disables the write to the ARF 208 (step 708). Disabling the write to ARF 208 prevents the results of instructions which were executed after the instruction which caused the trap condition from being incorrectly committed to the architectural state of the processor.

As the locations in the ACFIFOs are cleared, the ACFIFO-credit variable for that each ACFIFO is incremented. When the ACFIFOs are completely cleared and the ACFIFO-credit variables are restored to the maximum value, processor 200 handles the trap condition (step 712).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus that decouples register bypassing from pipeline depth, comprising:
an instruction execution pipeline on a processor;
an architectural register file (ARF) coupled to the instruction execution pipeline;
a working register file (WRF) coupled to the instruction execution pipeline;
an architectural-commit first-in-first-out (ACFIFO) structure coupled to the instruction execution pipeline and coupled to the ARF;
wherein an intermediate result generated by an originating instruction is stored in the WRF so that the intermediate result can be bypassed to subsequent dependent instructions in the instruction execution pipeline while the originating instruction remains in the instruction execution pipeline; and
wherein the intermediate result generated by an originating instruction is also stored in the ACFIFO structure and the intermediate result is written to the ARF when the originating instruction retires from the instruction execution pipeline;
whereby using the ACFIFO allows the conservation of area and power on the processor, as well as facilitating alternative forms of in-order instruction execution.

2. The apparatus of claim 1, further comprising:
at least one additional instruction execution pipeline on the processor coupled to the ARF and coupled to the WRF;
an ACFIFO structure coupled to each additional instruction execution pipeline and coupled to the ARF;
wherein an intermediate result generated by a second originating instruction in the additional instruction execution pipeline is stored in the WRF and the intermediate result is bypassed from the WRF to subsequent dependent instructions in the additional instruction execution pipeline while the second originating instruction remains in the additional instruction execution pipeline; and
wherein the intermediate result generated by the second originating instruction in the additional instruction execution pipeline is also stored in the ACFIFO structure and the intermediate result is written to the ARF when the second originating instruction retires from the additional instruction execution pipeline.

3. The apparatus of claim 2, further comprising an age pointer indicating the pipeline position of a second originating instruction issued at the same time as the originating instruction.

4. The apparatus of claim 1, wherein the ACFIFO structure is a register file configured as a first-in-first-out (FIFO) ring buffer with a plurality of locations for storing intermediate results.

5. The apparatus of claim 1, further comprising:
an enqueue pointer that indicates a location within the ACFIFO structure for storing an intermediate result generated by the execution of a subsequent originating instruction;
a commit pointer that indicates a location within the ACFIFO structure where an intermediate result was stored by an originating instruction that has passed a trap stage of the instruction execution pipeline; and
a dequeue pointer that indicates a location within the ACFIFO structure where the intermediate result, which is ready to be written to the ARF, is stored.

6. The apparatus of claim 1, further comprising an ACFIFO-credit variable used to track the availability of storage locations within the ACFIFO structure.

7. The apparatus of claim 6, further comprising a WRF-credit variable used to track the availability of storage locations within the WRF structure.

8. A method for decoupling register bypassing from pipeline depth, comprising:
storing an intermediate result generated by an originating instruction to an allocated location in an ACFIFO structure and to an allocated location in a WRF;
bypassing the intermediate result from the WRF to subsequent dependent instructions until the originating instruction retires from the instruction execution pipeline;
storing the intermediate result from the ACFIFO structure to a location in an ARF when the originating instruction retires from the instruction execution pipeline; and
removing the intermediate result from the WRF and the ACFIFO structure when the intermediate result has been stored in the ARF;
whereby using the ACFIFO allows the conservation of area and power on the processor, as well as facilitating alternative forms of in-order instruction execution.

9. The method of claim 8, further comprising maintaining
an enqueue pointer which indicates a location within the ACFIFO structure for storing an intermediate result generated by the execution of a subsequent originating instruction;
a commit pointer which indicates a location within the ACFIFO structure where an intermediate result was stored by an originating instruction that has passed a trap stage of the instruction execution pipeline; and
a dequeue pointer which indicates a location within the ACFIFO structure where an intermediate result, which is ready to be written to the ARF, is stored.

10. The method of claim 9, wherein maintaining pointers involves:
shifting an enqueue pointer to indicate a next location in the ACFIFO structure as each instruction is issued;
shifting a commit pointer to indicate a next location in the ACFIFO structure as each originating instruction passes a trap stage of the instruction execution pipeline; and
shifting the dequeue pointer to indicate a next location in the ACFIFO structure after the stored intermediate result indicated by the dequeue pointer has been successfully written to the ARF.

11. The method of claim 10, further comprising disabling ARF writes from the ACFIFO structure when:
the dequeue pointer indicates the same location as the commit pointer;
the processor is clearing the pre-trap-stage intermediate results from the ACFIFO structure during the handling of a trap;
an ARF control circuit disables writes to the ARF; or
when an entry in a location of the ACFIFO structure indicated by the dequeue pointer is not valid.

12. The method of claim 9, further comprising storing an index for the location in the ACFIFO specified by the enqueue pointer as each instruction is issued, wherein the index is used to store the intermediate results to the ACFIFO after the instruction is executed.

13. The method of claim 8, further comprising decrementing the value of an ACFIFO-credit variable as locations in the ACFIFO structure are allocated and incrementing the value of the ACFIFO-credit variable as locations within the ACFIFO structure are released.

14. The method of claim 13, further comprising halting the issuance of instructions while the value of the ACFIFO-credit variable equals zero.

15. The method of claim 8, further comprising decrementing the value of a WRF-credit variable as locations in the WRF are allocated and incrementing the value of the WRF-credit variable as locations in the WRF are released.

16. The method of claim 15, further comprising halting the issuance of instructions if the value of the WRF-credit variable equals zero.

17. The method of claim 1, further comprising:
storing an intermediate result generated by a second originating instruction from a second instruction execution pipeline to an allocated location in an additional ACFIFO structure and to an allocated location in the WRF;
bypassing the intermediate result from the WRF to subsequent dependent instructions in the additional instruction execution pipeline until the second originating instruction retires from the additional instruction execution pipeline;
storing the intermediate result from the additional ACFIFO structure to a location in the ARF when the second originating instruction retires from the additional instruction execution pipeline; and
removing the intermediate result from the WRF and the additional ACFIFO structure when the intermediate result has been stored in the ARF.

18. The method of claim 17, further comprising maintaining an age pointer which indicates the pipeline position of a second originating instruction issued at the same time as the originating instruction.

19. A computer system, comprising:
a processor;
a memory coupled to the processor;
an instruction execution pipeline on a processor;
an architectural register file (ARF) coupled to the instruction execution pipeline;
a working register file (WRF) coupled to the instruction execution pipeline;
an architectural-commit first-in-first-out (ACFIFO) structure coupled to the instruction execution pipeline and coupled to the ARF;
wherein an intermediate result generated by an originating instruction is stored in the WRF so that the intermediate result can be bypassed to subsequent dependent instructions in the instruction execution pipeline while the originating instruction remains in the instruction execution pipeline; and
wherein the intermediate result generated by an originating instruction is also stored in the ACFIFO structure and the intermediate result is written to the ARF when the originating instruction retires from the instruction execution pipeline;
whereby using the ACFIFO allows the conservation of area and power on the processor, as well as facilitating alternative forms of in-order instruction execution.

20. The computer system of claim 19, further comprising:
at least one additional instruction execution pipeline on the processor coupled to the ARF and coupled to the WRF;
an ACFIFO structure coupled to each additional instruction execution pipeline and coupled to the ARF;
wherein an intermediate result generated by a second originating instruction in the additional instruction execution pipeline is stored in the WRF and the intermediate result is bypassed from the WRF to subsequent dependent instructions in the additional instruction execution pipeline while the second originating instruction remains in the additional instruction execution pipeline; and
wherein the intermediate result generated by the second originating instruction in the additional instruction execution pipeline is also stored in the ACFIFO structure and the intermediate result is written to the ARF when the second originating instruction retires from the additional instruction execution pipeline.

21. The computer system of claim 20, further comprising an age pointer indicating the pipeline position of a second originating instruction issued at the same time as the originating instruction.

22. The computer system of claim 19, further comprising:
an enqueue pointer that indicates a location within the ACFIFO structure for storing an intermediate result generated by the execution of a next originating instruction;
a commit pointer that indicates a location within the ACFIFO structure where a stored intermediate result was generated by an originating instruction that has passed a trap stage of the instruction execution pipeline; and
a dequeue pointer that indicates a location within the ACFIFO structure where the stored intermediate result is ready to be written to the ARF.
